(19) United States
(12) Patent Application Publication
(10) Pub. No.: US 2003/0005046 A1
(43) Pub. Date: Jan. 2, 2003

(54) System and method for managing marketing applications for a website

(75) Inventors: Lawrence Kavanagh, Cincinnati, OH (US); Ralph Ewry, Cincinnati, OH (US); William Brohaugh, Amelia, OH (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Lagniappe Marketing

(21) Appl. No.: 10/161,603

(22) Filed: Jun. 5, 2002

Related U.S. Application Data
(60) Provisional application No. 60/295,850, filed on Jun. 6, 2001.

(51) Int. Cl. G06F 15/16

(52) U.S. Cl. 709/203

(57) ABSTRACT

A system and method for managing marketing applications for a website is disclosed. The website has webpages that perform e-commerce transaction by offering products to users and customers of the website. The website is coupled to a database having database tables. The database tables include information in performing marketing processes and applications. Further, a cookie identification and a customer number may be received or generated that identifies the user to the website. The cookie identification and customer number are used within the database tables along with product numbers and other information to display products or information to the user in a tailored manner, to generate upsell products for display, to deliver abandoned cart emails to the user. Further, the user may click on an embedded URL to provide unique information referenced in the database table. The user registers for e-newsletters on the website and promotional copy that is displayed using the cookie identification, the customer number and the database table. Other marketing applications and features are implemented using customer information, product information and the database tables to increase potential sales.

### CROSS REFERENCE TO RELATED APPLICATIONS

This application claim benefit of U.S. Provisional Patent Application No. 60/295,850 entitled “System and Method for Website Management for Marketing Applications,” filed Jun. 6, 2001, which is hereby incorporated by reference.

### BACKGROUND OF THE INVENTION

1. Field of the Invention

The present invention relates to managing websites that market goods and/or services, and, more particularly, the invention relates to managing data to and from the website in an e-commerce environment to increase website traffic and to better market the goods and/or services on the website.

2. Discussion of the Related Art

E-commerce applications that market and sell products and services over the Internet are known. The number of consumers using online commerce to purchase or sell keeps increasing as more people become comfortable with transacting over the Internet. Further, the number of websites engaged in online commerce also increases as potential entrepreneurs take advantage of low overhead and worldwide access for their goods and services. As the number of online consumers and businesses increases, the number of websites and consumer choices also increases. Unlike brick and mortar stores, a large variety of online commerce websites may be available to a consumer in one location.

To increase website traffic and to attract potential customers, online commerce websites should aggressively market their goods and/or services. With an increasing number of competitors, online commerce websites aim to stand out from the crowd with advertisements, inducements such as sales and coupons, name recognition, targeted customers and direct marketing. Old and new marketing techniques have been developed to market online commerce websites, but the costs or resources may be too high for small or new online ventures. Further, these techniques may not be effective for a specific website. Thus, online commerce websites seek to increase potential customers and to effectively market their goods and/or services without prohibitive marketing costs. Moreover, direct marketing potential has not been realized. Direct marketing practices may include selling to customers via catalogs and other mail solicitations.

### SUMMARY OF THE INVENTION

The preferred embodiments of the present invention are directed to a system and method for managing marketing applications and processes for a web-based business. The web-based business may use a website or webpages to conduct business transactions for products and services to users and customers over a network, such as, e.g., the Internet.

Additional features and advantages of the preferred embodiments will be set forth in the description which follows, and in part will be apparent from the description, or may be learned by practice of the invention. The objectives and other advantages of various embodiments of the invention may be realized and attained by the structure particularly pointed out in the written description and claims hereof as well as the appended drawings.

According to some embodiments, a method for displaying a webpage in a tailored manner is disclosed. The method includes matching a cookie identification to a customer number in a customer database table. The method also includes matching a source code with the customer number. The method also includes matching the source code in a source code database table to an offer code. The method also includes matching the offer code to corresponding offer text and an offer discount in an offer code database table. The method also includes displaying a webpage with the offer text and the offer discount.

According to some embodiments, a method for generating upsell products for display on a webpage is disclosed. The method includes measuring a frequency of a combination of a product number and an upsell product number. The method also includes entering the combination of the product number and the upsell product number and the frequency into an upsell product database table. The method also includes referencing the upsell product database table for the product number. The method also includes determining a rank for the upsell product number according to the frequency. The method also includes displaying the upsell product number according to the rank.

According to some embodiments, a method for delivering abandoned cart emails to a user is disclosed. The user visits a website. The method includes referencing a visit detail database table for a cookie identification. The method also includes creating a list including the cookie identification. The method also includes removing the cookie identification from the list when the cookie identification is within a customer order detail database table. The method also includes removing the cookie identification from the list according to an email sent flag in a shopping cart database table. The method also includes matching the cookie identification to an email address in the shopping cart database table. The method also includes populating a template email with text and the email address. The method also includes sending the email to the user.

According to some embodiments, a method for registering a user for an e-newsletter on a webpage is disclosed. The method includes displaying a text box for an email address from the user. The method also includes recording the email address for a cookie identification and a customer number in a customer database table. The method also includes referencing an offer code database table having promotional copy according to the offer code. The method also includes replacing the text box with the promotional copy on the webpage.

According to some embodiments, a method for populating categories of products for display within an e-commerce environment is disclosed. The method includes determining a time period. Orders for the products occur during the time period. The method also includes entering a quantity order and a gross sales into a product sales database table for an order number within the orders. The method also includes referencing a product number in the product sales database table. The method also includes entering the gross sales for the product number into a category rank in a category database table. The method also includes displaying the product number according to the category rank.

According to some embodiments, a method for ranking products in response to a search on a website is disclosed. The method includes entering a search term into a search text box at the website. The method also includes matching the search term to at least one product name listed in a category database table. The method also includes displaying at least one product name according to a corresponding category rank within the category database table.

According to some embodiments, a method for displaying an offline promotion on a webpage in an e-commerce environment is disclosed. The method includes matching the customer number with a source code in a mailed database table. The method also includes matching the source code with an offer code in a source code database table. The method also includes matching the offer code with data in an offer code database table. The method also includes displaying the data on the webpage.

It is to be understood that both the foregoing general description and the following detailed description are exemplary and explanatory and do not limit the broad scope of the invention as claimed.

### BRIEF DESCRIPTION OF THE DRAWINGS

The accompanying drawings, which are included to provide further understanding of preferred embodiments of the invention and are incorporated in and constitute a part of this specification, illustrate preferred embodiments of the invention and together with the description serve to explain the principles of the preferred embodiments of the invention. In the drawings:

FIG. 1A illustrates a flowchart for displaying a website in a tailored, dynamic manner in accordance with an embodiment of the present invention.

FIG. 1B illustrates a flowchart for displaying a website in a tailored, dynamic manner in accordance with an embodiment of the present invention.

FIG. 2 illustrates the database tables used in conjunction with FIG. 1.

FIG. 3 illustrates a flowchart for generating upsell items in accordance with an embodiment of the present invention.

FIG. 4 illustrates the database tables used in conjunction with FIG. 3.

FIG. 5 illustrates a flowchart for generating and delivering “abandoned cart” email to customers in accordance with an embodiment of the present invention.

FIG. 6 illustrates the database tables used in conjunction with FIG. 5.

FIG. 7 illustrates a flowchart for registering immediately a customer to receive e-newsletters without leaving the home page in accordance with an embodiment of the present invention.

FIG. 8 illustrates a flowchart for populating categories with items ranked by sales for a predetermined period of time in an automatic manner in accordance with an embodiment of the present invention.

FIG. 9 illustrates the database tables used in conjunction with FIG. 8.

FIG. 10 illustrates a flowchart for prioritizing search queries according to gross sales figures in accordance with an embodiment of the present invention.

FIG. 11 illustrates a flowchart for displaying an offline promotion mailed to a user in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The described preferred embodiments pertain to a website management system and methods that promote direct marketing principles in an online environment. Website management may be implemented using software that executes within the system. The system may include servers, nodes, client computers, relational databases that store pertinent information, data pipes, routers, hosting services, and the like. The software may be a software tool that references a set of relational database tables, indices, and procedures that store website data and processes for selecting and displaying the appropriate data at the appropriate time. The software may include applications to increase website traffic and revenue by the methods disclosed below.

In various embodiments, illustrative computers and/or servers employed for implementing some embodiments of the invention can include, e.g.: central processing units; memory (e.g., RAM, etc.); digital data storage (e.g., hard drives, etc.); input/output ports (e.g., parallel and/or serial ports, etc.); user interfaces (e.g., monitors, etc.); data entry devices (e.g., key boards, etc.); etc. In some embodiments, client computers may contain browser software for interacting with the server(s), such as, for example, using hypertext transfer protocol (HTTP) to make requests of the server(s) via the Internet or the like.

The applications may include the dynamic display of website content tailored to the user, automatic generation of upsell items through the analysis of previous order information, automatic generation and delivery of “abandoned cart” email to customers that quit shopping on the website, immediate customer signup for e-newsletters without leaving the home page and with automatic replacement of email signup text with new offer text, automatic population of categories with items ranked by sales for a specified period, use of sale figures to prioritize the responses to website search queries, and automatic website display of offline, or mailed, promotions. The described preferredembodiments utilize the software and its applications in an automatic manner to reduce the time spent by website managers for data management. Further, the described preferred embodiments facilitate unique website displays that may not manually be created in an efficient manner.

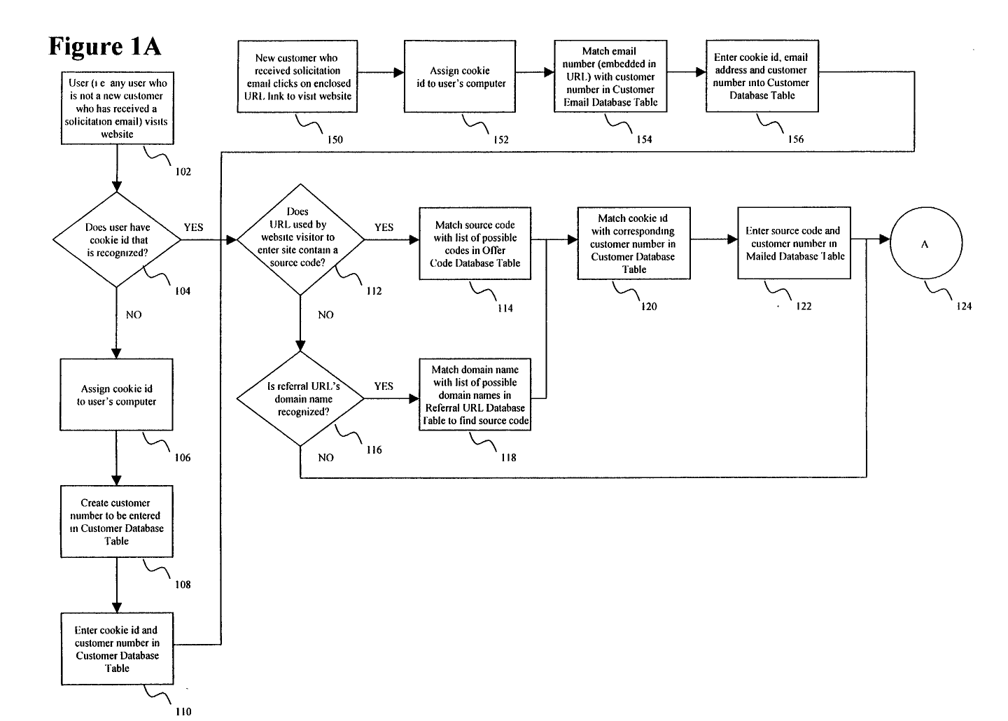

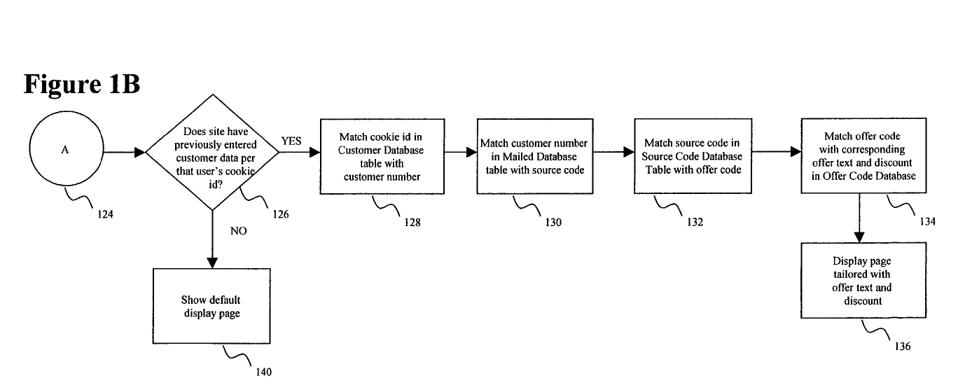

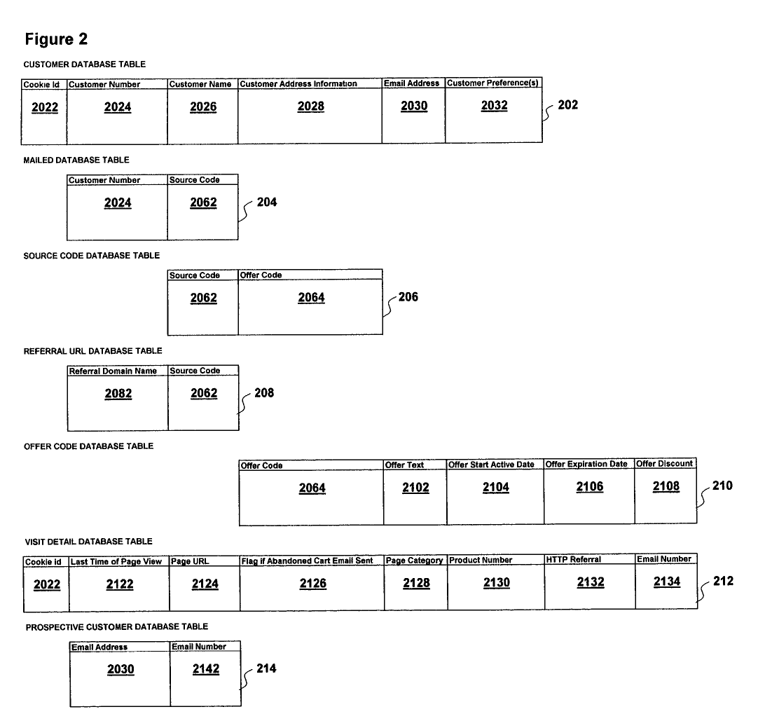

FIGS. 1A and 1B depict flowcharts for displaying a website in a tailored, dynamic manner in accordance with an embodiment of the present invention. FIGS. 1A and 1B may be utilized in conjunction with each other to disclose the embodiments of the present invention. Dynamic display of website content may include two components, such as website visitor identification and dynamically tailoring the website display. FIGS. 1A and 1B, however, are not limited to these two components, and may include other components as deemed appropriate by one skilled in the art. Descriptive copy, product prices, and unique offers are some of the content that may be individually displayed to a customer on the website. FIG. 2 depicts the database tables used in conjunction with FIG. 1.

Step 102 executes by detecting a website visitor, or user, visiting the website. The user may visit the website by entering the website via a webpage displayed on the user computer using a web browser. In step 102, the user may be defined as a user who is not a new customer and who has not received a solicitation email. Step 104 executes by determining whether the user has a cookie identification on the user's computer that the described preferred embodiments recognize. The cookie identification may be the primary key used to determine how other variables and data within the attached database relate to the user, and how information may be used to tailor the website display for the user.

If step 104 is no, then step 106 executes by assigning a cookie identification 2022, as depicted in FIG. 2, to the user's computer. Cookie identification 2022 preferably is generated as a ten-digit alphanumeric text that is placed and stored on the user's computer during the first website visit. Cookie identification 2022 is created as a primary key in the website management database. Step 108 executes by creating a customer number 2024 to be entered in a customer database table 202, as depicted in FIG. 2. The described preferred embodiments enable the website to associate cookie identification 2022 with a ten digit identification in the software database. This feature allows the software database to retrieve and act upon any customer data that may exist. Step 110 executes by entering cookie identification 2022 and customer number 2024 into customer database table 202.

When step 104 is yes, then the user has visited the website previously from the same computer as cookie identification 2022 already exists. Cookie identification 2022 may be the primary key that is used in combination with other key data to tailor the website display. Other data, however, may be determined before cookie identification 2022 is used. Thus, if step 104 is yes, then step 112 executes by determining whether the referral uniform resource locator (“URL”) used by the website user to enter the website contains a source code included in the URL address. The described preferred embodiments attempt to match source code 2062 listed inside source code database table 206 with any text that follows the text “sid=.” If yes, then step 114 executes by matching the matching offer code with a list of possible offer codes in offer code database table 210. If step 112 is no, then step 116 executes by determining whether the referral URL's domain name is recognized. The described preferred embodiments check referral URL domain name 2082. If step 116 is yes, then step 118 executes by matching referral domain name 2082 with a list of possible domain names in referral URL database table 208 to find source code 2062. If step 116 is no, then the described preferred embodiments proceed to step 124, as disclosed below.

Step 120 executes by matching cookie identification 2022 with corresponding customer number 2024 in customer database table 202. Step 122 executes by entering the matching source code 2062 and customer number 2024 in mailed database table 204. Step 124 executes by continuing the disclosed embodiments to FIG. 1B, which discloses steps 126 through 140.

Step 126 executes by determining whether the website has previously entered customer data for the user per the user's cookie identification. The described preferred embodiments attempt to identify a cookie identification 2022 in customer database table 202. If yes, then step 128 executes by matching cookie identification 2022 in customer database table 202 with customer number 2024. Cookie identification 2022 also may correspond to a customer name 2026, a customer address information 2028, an email address 2030, and a customer preference(s) 2032 for customer number 2024. Step 130 executes by matching customer number 2024 with source code 2062 in mailed database table 204. Step 132 executes by matching source code 2062 with offer code 2064 in source code database table 206. Step 134 executes by matching offer code 2064 with corresponding an offer text 2102, an offer start active date 2104, an offer expiration date 2106, and an offer discount 2108 in offer code database table 210. Step 136 executes by displaying a webpage tailored with offer text 2102 and offer discount 2108 that correspond to offer code 2064. Thus, the webpage is tailored with information from the database tables according to data provided by the user without the need for special coupons or information from the user. If step 126 is no, then step 140 executes by displaying a default webpage.

Referring back to FIG. 1A, steps 150-156 disclose embodiments of the present invention that feature a new customer to the website. In contrast to the embodiments disclosed with reference to step 102, steps 150-156 pertain only to new customers, or users, that have also received a solicitation email with an enclosed URL. Step 150 executes by detecting the new user when the new user clicks on the URL link to visit the website. Step 152 executes by assigning cookie identification 2022 to the user's computer. Step 154 executes by matching email number 2142 embedded in the URL with email address 2030 in prospective customer database table 214. Step 516 executes by entering cookie identification 2022, email address 2030 and customer number 2024 into customer database table 202. The described preferred embodiments then may proceed to step 112, accordingly.

Preferably, cookie identification 2022 for the user and other appropriate data elements disclosed above may populate selected variable data fields on the website. In other words, the user's cookie identification may program what the user sees on the website display. Any or all fields that are used on the website may be variable. As the user navigates the website, a visit detail database table 212 of FIG. 2 may be populated per cookie identification 2022. Visit detail database table 212 may include a last time of page view 2122, a page URL 2124, a flag if abandoned cart email sent 2126, a page category 2128, a product number 2130, a HTTP referral 2132.

The embodiments disclosed with reference to FIGS. 1A and 1B may integrate offline marketing strategies with online website presentation. By matching the data collected throughout the database tables depicted in FIG. 2, those skilled in the art may track data throughout the various sales channels. For example, a referral URL may include a source code that identifies the latest catalog that a user received. The referral URL also may include another email source code that identifies the latest email that the user received. Thus, multiple ways of measuring sales may exist for more accurate data collection. For example, sales may be measured per each catalog mailed or per each email delivered.

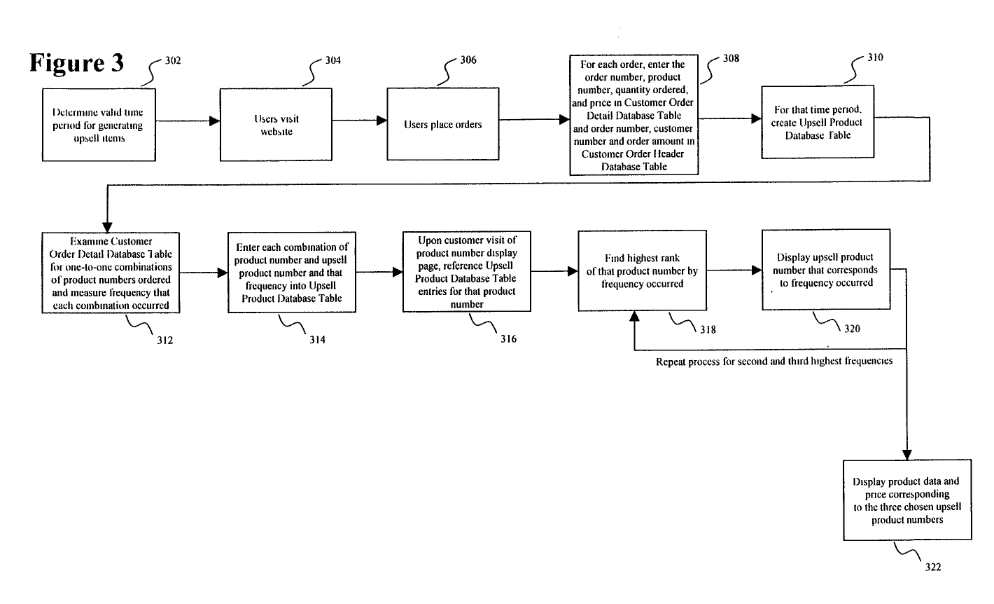

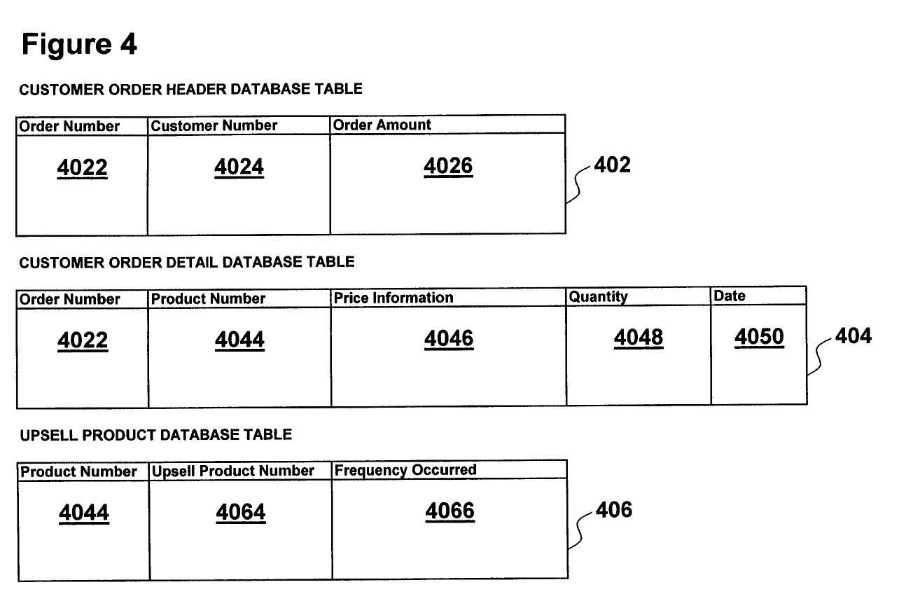

FIG. 3 depicts a flowchart for generating upsell items in accordance with an embodiment of the present invention. The described preferred embodiments pertain to the automatic generation of upsell items that are displayed by ranking of the highest gross sales. When selling to consumers, it may be more profitable to upsell or increase the average amount that each consumer spends. FIG. 4 depicts the database tables used in conjunction with FIG. 3.

Step 302 executes by determining a valid time period for generating upsell items. The time period may relate to the gross sales used in determining the upsell items. Within the time period, upsell product database table 406 of FIG. 4 may be created. Step 304 executes by users or consumers visiting the website. Step 306 executes by the user placing an order to the website. Step 308 executes by entering, for each order, an order number 4022, a product number 4044, a price 4046, a quantity ordered 4048, and a date 4050 into a customer order detail database table 404, as depicted in FIG. 4. Further, order number 4022, a customer number 4024, and an order amount 4026 may be entered into customer order header database table 402.

Step 310 executes by creating upsell product database table 406. Step 312 executes by examining customer order detail database table 404 for one-to-one combinations of product numbers ordered and measuring the frequency that each combination occurred. Step 314 executes by entering each combination of product number 4044, and an upsell product number 4064, and a corresponding frequency occurred 4066 into upsell product database table 406. Upsell product database table 406 may be referenced by the described preferred embodiments to select the products that may be displayed with the original product's webpage.

Step 316 executes by referencing upsell product database table 406 entries for product number 4044 upon customer visit to the display page for product number 4044. The described preferred embodiments may search for all listings of product number 4044. Step 318 executes by finding the highest rank of product number 4044 by frequency occurred 4066. The described preferred embodiments find the highest frequency of every listing with product number 4044. Step 320 executes by displaying upsell product number 4064 that corresponds to the highest frequency occurred 4066. The described preferred embodiments display the product data and price of upsell product number 4064 that corresponds to the highest frequency occurred 4066. Steps 318 and 320 may be repeated to display the upsell products that have the next highest frequencies. Preferably, steps 318 and 320 are repeated twice to display the upsell products that have the second and third highest frequencies. The described preferred embodiments, however, are not limited in the number of times steps 318 and 320 may be repeated, and in the number of upsell products to display. Step 322 executes by displaying product data and prices corresponding to the selected upsell product numbers 4064.

Thus, according to the preferredembodiments, every product listed on a website may be accompanied by the most likely products that a consumer also may purchase with the original product. Preferably, three most likely products are displayed. In contrast, known websites may use manual user input to display related upsell products. The preferredembodiments automatically determine the most popular upsell items and display these items; the most popular upsell items and display may be updated on a periodic basis.

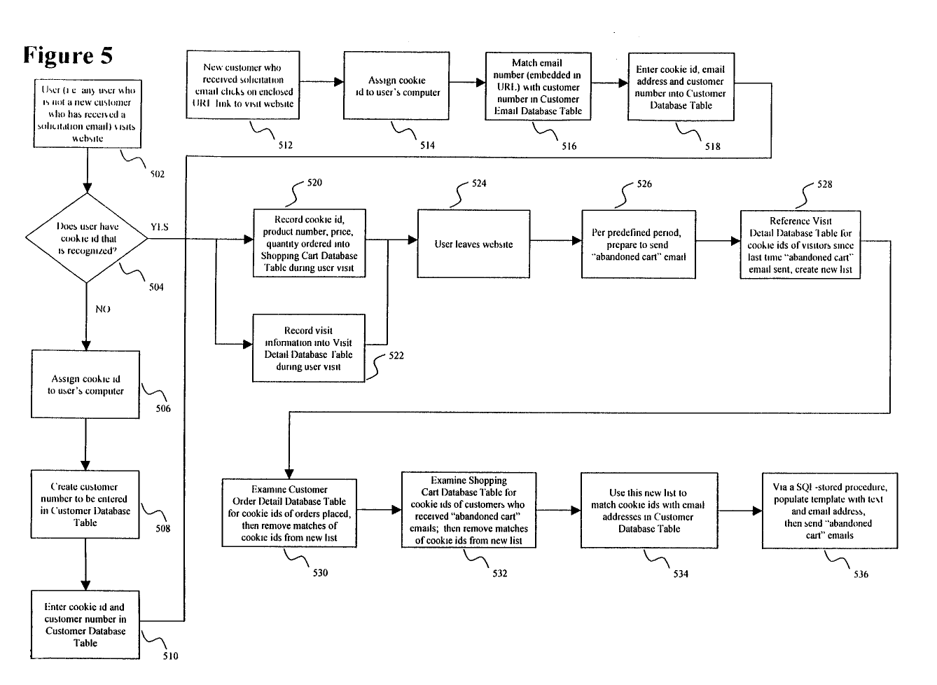

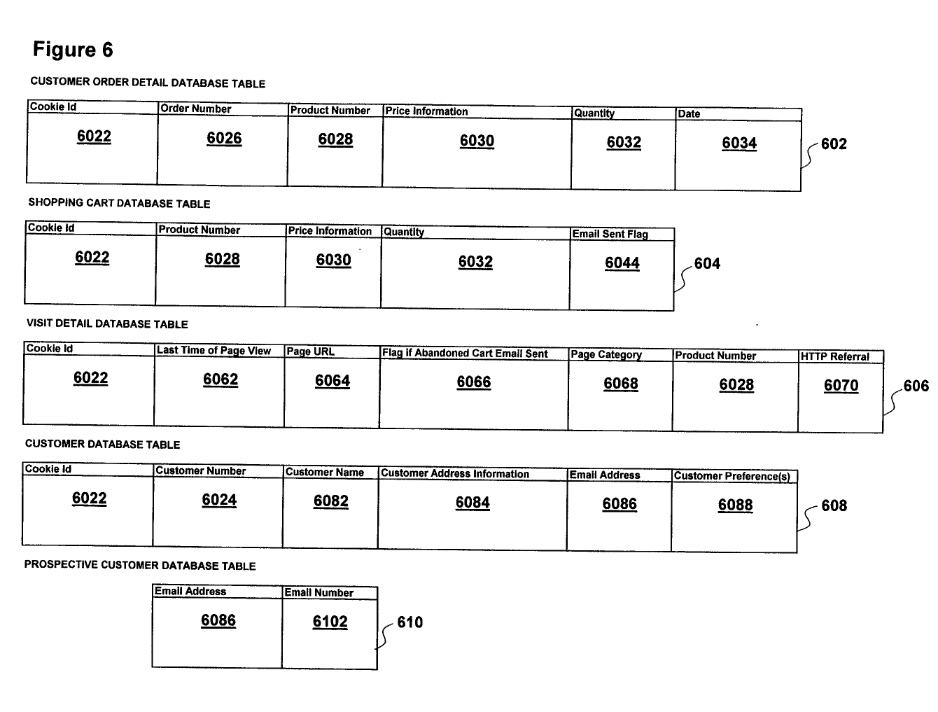

FIG. 5 depicts a flowchart for generating and delivering “abandoned cart” email to customers in accordance with an embodiment of the present invention. FIG. 6 depicts the database tables used in conjunction with FIG. 5. The described preferred embodiments use automatic generation and delivery of abandoned cart email to customers, or users, that quit shopping on a website. Step 502 executes by detecting a user visiting the website. Preferably, the user is not a new customer who has received a solicitation email having an embedded link to the website. Step 504 executes by determining whether the user has a cookie identification 6022, as depicted in FIG. 6, that is recognized by the software executing according to the disclosed embodiments. If no, then step 506 executes by assigning cookie identification 6022 to the user's computer. Step 508 executes by creating a customer number 6024 to be entered in a customer database table 608, as depicted in FIG. 6. Step 510 executes by entering cookie identification 6022 and customer number 6024 into customer database table 608. Then, the described preferred embodiments proceed to step 520. If step 504 is yes, then the described preferred embodiments proceed to step 520.

Steps 512-518 pertain only to new customers who have received a solicitation email and are visiting the website. Preferably, the new customer has received a solicitation email and has clicked on a URL link enclosed in that solicitation email to visit the website. Preferably, the new customer has not previously visited the website but has an email address recorded into prospective customer database table 610, as depicted in FIG. 6. The new customer may be solicited with an email containing a URL address that when clicked, will send the new customer to the website. An email number 6102 is embedded in the URL address. Step 512 executes by detecting this type of customer visiting the website. Step 514 executes by assigning cookie identification 6022 to the user's computer. Step 516 executes by matching email number 6102 embedded in the URL with email address 6086 in prospective customer database table 610. Step 518 executes by entering cookie identification 6022, email address 6086 and customer number 6024 into customer database table 608. The described preferred embodiments proceed to step 520.

Step 520 executes by recording cookie identification 6022, product number 6028, price 6030, and quantity 6032 into a shopping cart database table 604 during the user visit. The contents of the user's shopping cart are data elements in shopping cart database table 604. Shopping cart database table 604 also may include an email sent flag 6044 if an abandoned cart email has been sent. Step 522 executes by recording visit information into a visit detail database table 606 during user visit. Thus, according to steps 520-522, cookie identification 6022 is collected. Per the user's appropriate cookie identification 6022, the described preferred embodiments record product number(s) 6028 placed in the shopping cart in shopping cart database table 604. The described preferred embodiments also record the webpage URL 6064 viewed and the last time of page view 6062 in visit detail database table 606. Visit detail database table 606 includes cookie identification 6022, a last time of page view 6062, a webpage URL 6064, a flag if abandoned cart email sent 6066, a page category 6068, product number 6028, and an HTTP referral 6070. The information is recorded until step 524 executes by the user leaving the website.

Step 526 executes by preparing to send abandoned cart email per the period set by the website manager, or any entity. Step 528 executes by referencing visit detail database table 606 for cookie identifications 6022 of visitors, and creates a list. Preferably, the list is temporary. For the period since the last abandoned cart emails were sent, the described preferred embodiments references visit detail database table 606 for cookie identification(s) 6022 of visitors to the website during that period. The described preferred embodiments generate, or create, a new temporary list. Step 530 executes by examining customer order detail database table 602 for cookie identification(s) 6022 of orders placed and removing any matches of cookie identification(s) 6022 from the new list. Customer order detail database table 602 may include cookie identification 6022, order number 6026, product number 6028, price 6030, and quantity 6032.

Step 532 executes by examining shopping cart database table 604 for cookie identification(s) 6022 of customers, visitors, or users that received abandoned cart emails, as noted by email sent flag 6044. Step 532 also removes matches of cookie identification(s) 6022 from the new list. Step 534 executes by using the new list to match cookie identification(s) 6022 with email address(es) 6086 in customer database table 608. Customer database table 608 also may include customer number 6024, a customer name 6082, a customer address information 6084, and a customer preference(s) 6088. Step 536 executes by populating an email template with appropriate text for each email address 6086 via a SQL stored procedure, and sending these abandoned cart emails to customers that did not place an order during their last visit to the website.

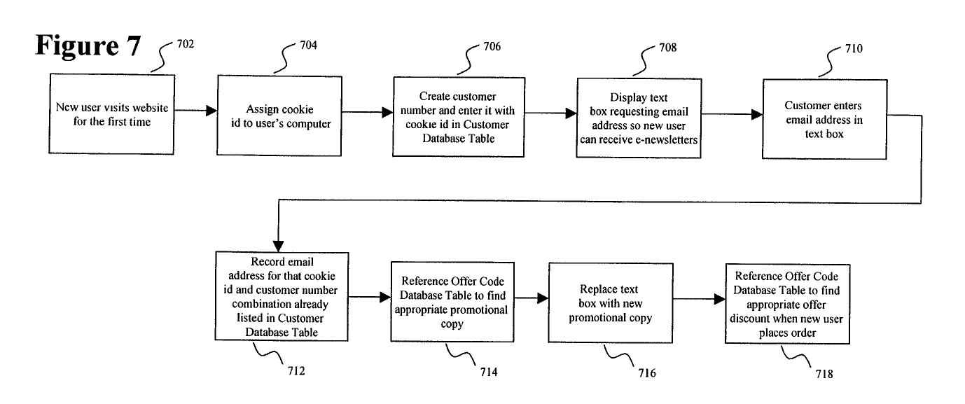

FIG. 7 depicts a flowchart for immediately registering a customer to receive e-newsletters without leaving the home page in accordance with an embodiment of the present invention. The described preferred embodiments allow immediate customer registration, or sign-up, to receive emailed newsletters without leaving the home page followed by the automatic replacement of the email signup text with new promotional text. Step 702 executes by detecting a new user visiting a website for the first time. Step 704 executes by assigning a cookie identification to the user's computer, such as cookie identification 2022. Step 706 executes by creating a customer number, such as customer number 2024, and entering the customer number in a customer database table, such as customer database table 202.

Step 708 executes by displaying a text box requesting an email address so the new user can receive e-newsletters. The user may see a text box on the webpage that requests the user to enter an email address if the user desires to receive email newsletters. Step 710 executes by the customer entering an email address in the text box. Step 712 executes by recording the email address for that cookie identification and customer number combination already listed in the customer database table. Thus, if a new user types in the email address and enters it, then the email address is entered into the customer database table corresponding to the cookie identification and customer number combination previously entered.

Step 714 executes by referencing an offer code database table, such as offer code database table 210, to find the appropriate promotional copy. Preferably, simultaneous to step 712, the described preferred embodiments recognize that data has been entered. The described preferred embodiments reference the offer code database table to find the appropriate promotional text to display to the user. The offer code database table may be referenced according to the email address, or any other variable within the customer database table. Step 716 executes by replacing the text box with new promotional copy. Thus, the e-newsletter sign-up text is replaced with the new promotional text. Step 718 executes by referencing the offer code database table to find appropriate offer discount, such as offer discount 2108, when the new user places an order. Thus, the e-newsletter text may not be displayed once the text is no longer desired, and fresh text is displayed that may boost sales revenue by increasing customer awareness of discounts and offers.

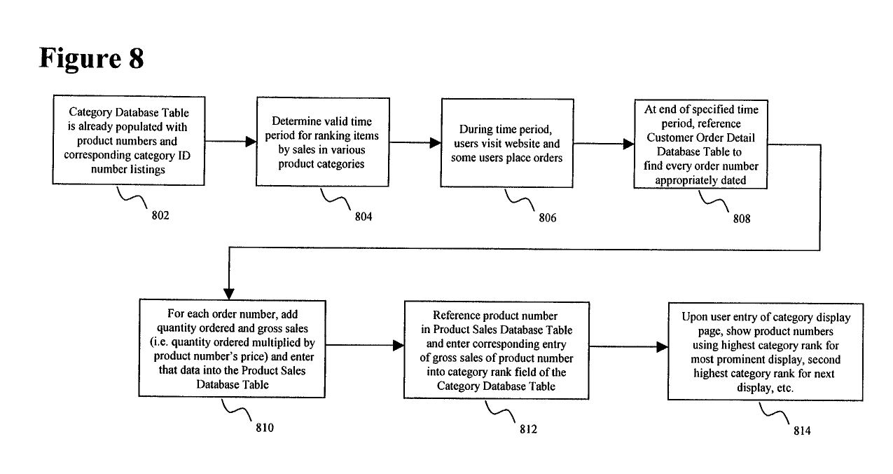

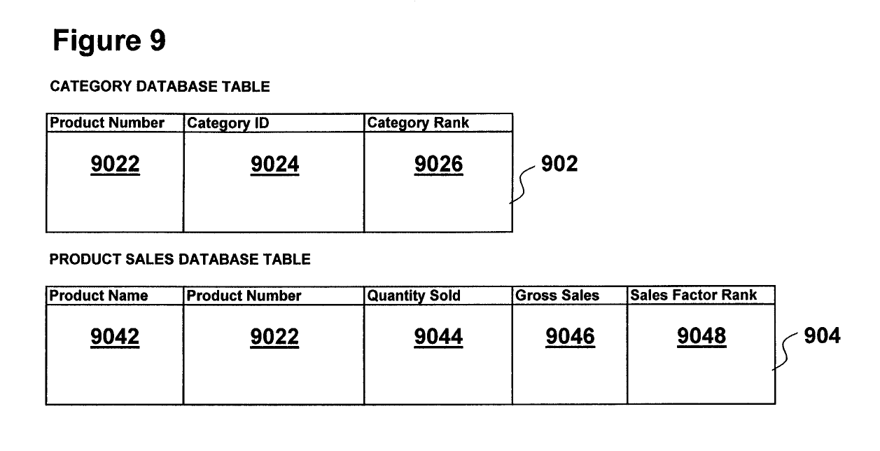

FIG. 8 depicts a flowchart for populating categories with items ranked by sales for a predetermined period of time in an automatic manner in accordance with an embodiment of the present invention. FIG. 9 depicts the database tables used in conjunction with FIG. 8. Step 802 executes by ensuring that before the start of a time period, a category database table 902 already is populated with product number(s) 9022 and corresponding category identification number(s) 9024 listings. Step 804 executes by determining a valid time period for ranking items by sales in various product categories. Step 806 executes by users visiting the website during the time period, with some of the users placing orders.

Step 808 executes by referencing a customer order detail database table, such as customer order detail database table 602 of FIG. 6, to find every order number, such as order number 6026, appropriately dated with date 6034 at the end of the specified time period. Thus, the described preferred embodiments determine the order numbers from the customer order detail database table that occurred during the specified time period. Step 810 executes by adding the quantity sold and gross sales and entering this data into a product sales database table 904. Gross sales may be quantity sold multiplied by a product number's price. Product sales database table 904 is constructed in step 810. Product sales database table 904 may include a product name 9042, product number 9022, a quantity sold 9044, a gross sales 9046, and a sales factor rank 9048.

Step 812 executes by referencing product number 9022 in product sales database table 904 and entering the corresponding entry of sales factor rank 9048 of product number 9022 into category rank 9026 of category database table 902. Step 814 executes by showing product number(s) 9022 using highest category rank 9026 for most prominent display, second highest category rank 9026 for next display, and the like. Step 814 may occur upon user entry of a category display page.

The display of products within a category that a user may view is derived from calling category database table 902. When the user views the category, the described preferred embodiments populate the category with products listed in category database table 902 by using category rank 9026 to determine the relative position for each product number 9022. According to the described preferred embodiments, the term “category” may refer to a type of product, manufacturer, color, distinguishable feature, or the like. The category may be selected by the user or prompted to the user in response to queries or other information.

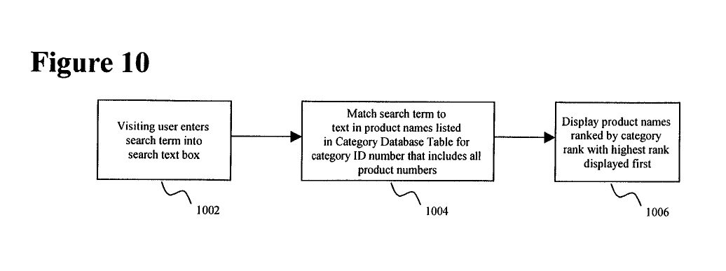

FIG. 10 depicts a flowchart for prioritizing search queries according to gross sales figures in accordance with an embodiment of the present invention. Known websites may display search results according to the frequency of the term being used in, for example, product names or text articles. Step 1002 executes by entering a search term into a search term text box from a visiting user. A text box on any webpage may solicit the user to enter a word or phrase to be found on the website. The word or phrase may become the search term. The described preferred embodiments captures the search term and queries a product sales database table, such product sales database table 904 of FIG. 9, to identify product names, such as product name(s) 9042, that contain the search term. The product names correspond to product numbers within the product sales database table, such as product number(s) 9022.

Step 1004 executes by matching the search term to the text in product names listed in a category database table, such as category database table 902 of FIG. 9, for a category identification number, such as category identification 9024, that includes all the product numbers found in the product sales database tables. Step 1006 executes by displaying the product names ranked by category rank, such as category rank 9026, with the highest rank displayed first. Thus, the most popular item that has the highest gross sales may be displayed first, the second most popular item may be displayed second, and the like in response to a search term entered by the user. The sales rankings may be defined over a specified period of time, such as monthly, and may be updated periodically and automatically. A merchandising tool, however, manually may override the order of the search results according to the described preferred embodiments.

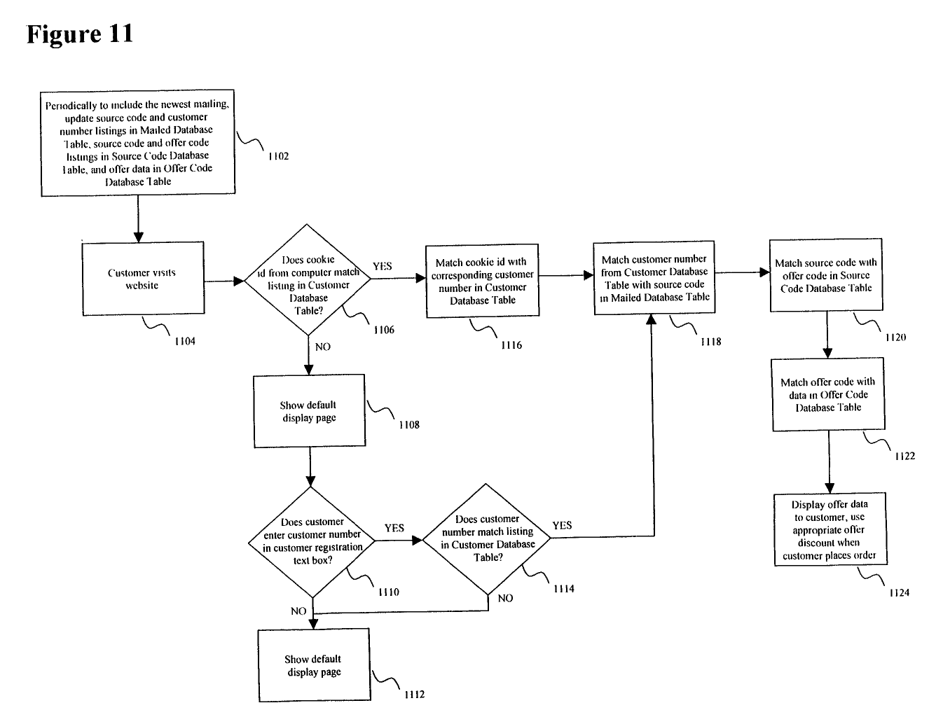

FIG. 11 depicts a flowchart for displaying an offline promotion mailed to a user in accordance with an embodiment of the present invention. When a user, or customer visits a website, an automatic webpage display of the latest offline promotion mailed to the user may be generated, even if the user has yet to enter any customer information. Step 1102 executes by updating the source code and the customer number listings in a mailed database table, the source code and offer code listings in a source code database table, and the offer data in an offer code database table. For example, referring back to FIG. 2, the described preferred embodiments update source code 2062 and customer number 2024 in mailed database table 204, source code 2062 and offer code 2064 in source code database table 206, and offer text 2102, offer start active date 2104, offer expiration date 2106 and offer discount 2108 in offer code database table 210. The updating process may occur periodically to include the newest mailing sent to customers.

Step 1104 executes by visiting the website by a customer, user, or visitor. Step 1106 executes by determining whether the cookie identification matches listing in a customer database table. For example, referring back to FIG. 2, the described preferred embodiments determine if the cookie identification provided by the customer matches cookie identification 2022 in customer database table 202. If no, then step 1108 executes by showing a default display page to the customer. Step 1110 executes by determining whether the customer entered a customer number into a customer registration text box displayed on the website. Thus, the described preferred embodiments may display the default display page until the customer enters a customer number, such as customer number 2024, in the customer registration text box. If step 1110 is no, then step 1112 executes by showing the default display page.

If step 1110 is yes, then step 1114 executes by determining whether the customer number matches a customer number listing in the customer database table. For example, the described preferred embodiments determine whether the entered customer number matches customer number 2024 in customer database table 202. If no, then step 1112 is executed as disclosed above. If step 1114 is yes, then the described preferred embodiments proceed to step 1118 disclosed below.

If step 1106 is yes, then step 1116 executes by matching the cookie identification with the corresponding customer number in the customer database table. For example, the described preferred embodiments match cookie identification 2022 with customer number 2024 in customer database table 202 of FIG. 2. Step 1118 executes by matching the customer number from the customer database table with the source code in the mailed database table. For example, the described preferred embodiments match customer number 2024 from customer database table 202 with source code 2062 of mailed database table 204 of FIG. 2.

Step 1120 executes by matching the source code with the offer code in the source code database table. For example, the described preferred embodiments match source code 2062 with offer code 2064 in source code database table 206 of FIG. 2. Step 1122 executes by matching the offer code with data in the offer code database table. For example, the described preferred embodiments match offer code 2064 with data in offer code database table 210 of FIG. 2. The data may include offer text, an offer start active date, an offer expiration date, and an offer discount. Step 1124 executes by displaying the offer data to the customer, or user, and using the appropriate offer discount when the customer places an order. For example, the described preferred embodiments display the offer data in offer code database table 210 to the customer. Further, the described preferred embodiments may apply offer discount 2108 to any order placed by the customer. All of these actions may occur even if the customer has not entered any data on the website. The described preferred embodiments may reduce the number of steps to provide discount or offer information to a customer.

The described preferred embodiments pertain to methods and systems to market products and services in an e-commerce environment through the use of the novel features disclosed. E-commerce environment features may include accessing a webpage or website over the Internet, viewing products and services, and conducting business and transaction by sending data over the Internet to a host for the website or webpage. The described preferred embodiments include a database having database tables. The database tables may include fields for specific values used by the processes, methods, and procedures in updating, modifying, and presenting the website to a customer. A system may be utilized that executes the methods disclosed herein. The system may include the database coupled to a supported network, such as the Internet or a local area network, that provides data, information, data exchange capabilities, such as email, to nodes, computers, workstations, and the like. For example, the database may be used in conjunction with a web hosting service to provide data on products, offers, information, and the like on a webpage viewed by a customer on a computer via the Internet.

The data within the database tables may be manipulated to provide updated or tailored information to the customer without excessive steps or data entry from the customer. By using emails, URLs, and other known components of e-commerce, the described preferred embodiments use this information to promote marketing of products and services in a unique manner.

The database tables may reside in a database on a server coupled to the network. Alternatively, the database tables may reside in memory on different machines or servers that are accessible by a central software program. The described preferred embodiments may implement a software program including instructions executable on a computing platform that results in actions being performed using the database tables and other information. The software program may reside on a central computer or server, or may reside on a machine hosting the database tables disclosed above. The software may be downloaded to the website location or may reside with a third party for use by the website.

Preferably, the software program of the described preferred embodiments executes on a Microsoft Windows 2000™ platform as a software tool that utilizes active server pages developed in virtual basic script language to incorporate the features disclosed above. These features provide a website management system that is more dynamic and user-friendly than known systems. The software tool of the described preferred embodiments references a set of relational database tables, as disclosed above, indices, and procedures/process, as disclosed above, that store the website data and methods for selecting and displaying the appropriate and tailored data. Website traffic and e-commerce revenue may be maximized because of the benefits of the features disclosed above.

One feature may be the dynamic display of website content, such as descriptive copy, product prices, or unique offers, that is individually tailored to the user. Another feature may be the automatic generation of upsell items through the analysis of previous order information. Another feature may be the automatic generation and delivery of abandoned cart email to customers that quit shopping the website. Another feature may be customer sign-up for e-newsletters without leaving the webpage, or home page, and the automatic replacement of e-newsletter solicitation text with new offer text. Another feature may be the automatic population of categories with items ranked by sales for a predetermined period. Another feature may be the use of sales figures to prioritize the responses to website search queries. Another feature may be the automatic website display of an offline, or mailed, promotion.

For example, a user may receive an email or mailed catalog that prompts the user to visit the website. By using information within the email or provided by the user, the described preferred embodiments may provide tailored offers, product display, and other information to the user. During the user's visit, the described preferred embodiments may automatically provide upsell items that the user is more likely to find useful and purchase. The described preferred embodiments may automatically display the most popular items within a category that the user chooses thus more efficiently serving the user by reducing unnecessary navigation. If the user queries the website to find a particular word or phrase, the described preferred embodiments may automatically display the most popular items in order thus saving user time in searching the website. Without the user entering any data, the described preferred embodiments may present an offline promotion to the user and thus increase the likelihood that the user may make a purchase. The user may sign-up for an e-newsletter. After sign-up, the solicitation content may be replaced with promotional content or other information, thereby relieving the user from further navigation on the website. The database tables may be updated with information within the email or provided by the user. If the user leaves the website (in some cases, even if the user has done nothing more than enter the website), an email of items, products, or services within a shopping cart may be sent automatically to the user without referencing redundant data.

It will be apparent to those skilled in the art that various modifications and variations can be made in the wheel assembly of the present invention without departing from the spirit or scope of the invention. Thus, it is intended that the present invention covers all modifications and variations of this invention that come within the scope of any of the appended claims and their equivalents.

What is claimed is:

1. A method for displaying a webpage in a tailored manner, comprising:
matching a cookie identification to a customer number in a customer database table;
matching a referral URL domain name in a referral URL database table to a source code;
embedding said source code within a referral URL and matching said source code with said customer number;
matching a source code with said customer number;
matching said source code in a source code database table to an offer code;
matching said offer code to corresponding offer text and an offer discount in an offer code database table; and
displaying a webpage with said offer text and said offer discount.

2. The method of claim 1, further comprising receiving said cookie identification at said website.

3. The method of claim 1, further comprising entering said cookie identification corresponding to an email number into said customer database table

4. A method for generating upsell products for display on a webpage, comprising:
measuring a frequency of a combination of a product number and an upsell product number;
entering said combination of said product number and said upsell product number and said frequency into an upsell product database table;
referencing said upsell product database table for said product number;
determining a rank for said upsell product number according to said frequency; and
displaying said upsell product number according to said rank.

5. The method of claim 4, further comprising creating said upsell product database table for a specified time period.

6. A method for delivering abandoned cart emails to a user wherein said user visits a website, comprising:
referencing a visit detail database table for a cookie identification;
creating a list including said cookie identification;
removing said cookie identification from said list when said cookie identification is within a customer order detail database table;
removing said cookie identification from said list according to an email sent flag in a shopping cart database table;
matching said cookie identification to an email address in a customer database table;
populating a template email with text and said email address; and
sending said email to said user.

7. The method of claim 6, further comprising recording said cookie identification into said shopping cart database table for said user during a previous visit to said website.

8. A method for delivering abandoned cart emails to a new user, wherein said user receives a solicitation email and visits a website for the first time, comprising:
referencing an email number embedded in a referral URL enclosed in the solicitation email;
matching said email number to an email address in a prospective customer database table;
populating a customer database table with a cookie identification and said email address;
referencing a visit detail database table for said cookie identification;
creating a list including said cookie identification;
removing said cookie identification from said list when said cookie identification is within a customer order detail database table;
removing said cookie identification from said list according to an email sent flag in a shopping cart database table;
matching said cookie identification to said email address in said customer database table;
populating a template email with text and said email address; and
sending said email to said user.

9. A method for registering a user for an e-newsletter on a webpage, comprising:
displaying a text box for an email address from said user;
recording said email address for a cookie identification and a customer number in a customer database table;
referencing an offer code database table having promotional copy according to an offer code; and
replacing said text box with said promotional copy on said webpage.

10. The method of claim 9, further comprising entering said cookie identification and said customer number into said customer database table.

11. A method for populating categories of products for display within an e-commerce environment, comprising:
determining a time period, wherein orders for said products occur during said time period;
entering a quantity sold and a gross sales into a product sales database table for an order number within said orders;
determining a sales factor rank based upon said gross sales;
referencing a product number in said product sales database table;
entering said sales factor rank for said product number into a category rank in a category database table; and
displaying said product number according to said category rank.

12. The method of claim 11, further comprising sorting said category rank within said category.

13. A method for ranking products in response to a search on a website, comprising:
entering a search term into a search text box at said website;
matching said search term to at least one product name listed in a category database table; and
displaying said at least one product name according to corresponding category rank within said category database table.

14. The method of claim 13, further comprising identifying a category identification number for said at least one product name.

15. A method for displaying an offline promotion on a webpage in an e-commerce environment, comprising:
matching said customer number with a source code in a mailed database table;
matching said source code with an offer code in a source code database table;
matching said offer code with data in an offer code database table; and
displaying said data on said webpage.

16. The method of claim 15, further comprising matching a cookie identification with said customer number in a customer database table, wherein said cookie identification is received from a computer.
